(19) United States
(12) Patent Application Publication
(10) Pub. No.: US 2014/0267035 A1
(43) Pub. Date: Sep. 18, 2014

(54) Multimodal User Interface Design

(71) Applicant: Sirius XM Connected Vehicle Services Inc., Irving, TX (US)

(72) Inventors: Thomas Barton Schalk, Plano, TX (US); Paola Faoro, Boston, MA (US); Yan He, Plano, TX (US); Frank Hirschenberger, Highland Village, TX (US)

(73) Assignee: Sirius XM Connected Vehicle Services Inc., Irving, TX (US)

(21) Appl. No.: 14/195,242

(22) Filed: Mar. 3, 2014

Related U.S. Application Data
(60) Provisional application No. 61/788,956, filed on Mar. 15, 2013.
(60) Provisional application No. 61/817,051, filed on Apr. 29, 2013.

(51) Int. Cl. G06F 3/01; G06F 3/041

(52) U.S. Cl. CPC G06F 3/01; G06F 3/017; G06F 3/041
USPC 345/158; 345/156; 345/173

(57) ABSTRACT

A multimodal user interface is provided. A human machine interface in a vehicle utilizes a plurality of modalities. A cognitive model for secondary driving tasks indicates a best use of one or more particular modalities for performing each secondary driving task.

### CROSS-REFERENCE TO RELATED APPLICATIONS

This application claims priority to U.S. Provisional Application Ser. No. 61/788,956, filed on Mar. 15, 2013 and U.S. Provisional Application Ser. No. 61/817,051, filed Apr. 29, 2013, the entire disclosures of which are hereby incorporated herein by reference in their entireties.

### STATEMENT REGARDING FEDERALLY SPONSORED RESEARCH OR DEVELOPMENT

Not Applicable

### FIELD OF THE INVENTION

The present invention lies in the field of user interfaces. The present disclosure relates to a cognitive model for secondary driving tasks that facilitates human machine interface (HMI) design.

### BACKGROUND OF THE INVENTION

Prior art vehicle infotainment systems include systems that allow voice input or touch input for certain applications. However, the use of voice or touch as an input measure is quite rigid. The user does not have the ability to input information or provide commands in more than one way in a particular application. For example, most applications allow for only one input mode, e.g., turning a knob to increase the volume. Where more than one input mode is allowed, the second input mode usually does not make sense from a safety or operational standpoint. For example, some systems allow for voice input to increase/decrease the volume.

With respect to the presentation of information on a display to a user, most prior art in-vehicle systems present information to the user in the form of lists. From a safety standpoint, presenting lists to the user focuses the user's attention on the display screen and is a significant distraction.

Thus, a need exists to overcome the problems with the prior art systems, designs, and processes as discussed above.

### SUMMARY OF THE INVENTION

The invention provides a user interface that overcomes the hereinafore-mentioned disadvantages of the heretofore-known devices and methods of this general type and that provides such features with a multimodal user interface.

With the foregoing and other objects in view, there is provided, in accordance with the invention, a method for providing a multimodal user interface. A human machine interface in a vehicle that utilizes a plurality of modalities is provided. A cognitive model for secondary driving tasks, the cognitive model indicating a best use of one or more particular modalities for performing each secondary driving task is also provided.

In accordance with a further mode of the invention, the plurality of modalities include speech, touch, gesture, vision, sound, and haptic feedback.

In accordance with an added mode of the invention, speech, touch, and gesture are input modalities.

In accordance with an additional mode of the invention, vision, sound, and haptic feedback are output modalities.

In accordance with yet another mode of the invention, the cognitive model includes all or a subset of the plurality of modalities for any given secondary driving task.

In accordance with yet a further mode of the invention, gesture detection is activated prior to detection of gesture input.

In accordance with yet an added mode of the invention, gesture input includes at least one of a specific gesture: in a particular location relative to a touch display; using a particular hand shape; using a particular motion; and with particular temporal properties.

In accordance with yet an additional mode of the invention, a notification that gesture input is ready to be detected is provided.

In accordance with again another mode of the invention, gesture detection is allowed to time out when a valid gesture is not detected.

In accordance with again a further mode of the invention, three-dimensional gesture input is provided.

In accordance with again an added mode of the invention, the three-dimensional gesture input is at least one of translational motion of a hand and movement of the hand itself.

In accordance with again an additional mode of the invention, gesture input is used to: move images on a display of the vehicle; zoom the image in and out; control volume; control fan speed; and close applications.

In accordance with still another mode of the invention, gesture input is used to highlight individual icons on a display of the vehicle.

In accordance with still a further mode of the invention, a vehicle system is woken up using gesture input.

In accordance with still an added mode of the invention, haptic feedback is used to interrupt the secondary driving task.

In accordance with still an additional mode of the invention, the secondary driving task is initiated with a tap and then the user is prompted to speak information or a command.

In accordance with a further mode of the invention, a user is prompted using audio or text.

In accordance with an added mode of the invention, the audio is human voice or text-to-speech (TTS).

In accordance with an additional mode of the invention, a head-up display displays the text to the user.

In accordance with a concomitant feature of the invention, a conventional speech button is used to manage both speech and touch input modalities.

Although the invention is illustrated and described herein as embodied in a multimodal user interface, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is an exemplary embodiment of a sequence diagram of subtasks for a complex navigation task;

FIG. 2 is an exemplary embodiment of common multimodal flows for several secondary tasks;

FIG. 3 is an exemplary embodiment of a sequence diagram of subtasks associated with the complex navigation task shown in FIG. 1;

FIG. 4 is a diagrammatic illustration of an exemplary embodiment of task initiation using a speech button;

FIG. 5 is a diagrammatic illustration of an exemplary embodiment of flows for speech recognition error handling;

FIG. 6 is a diagrammatic illustration of an exemplary embodiment of a category screen;

FIG. 7 is a diagrammatic illustration of an exemplary embodiment of a category screen having large icons on a first page;

FIG. 8 is a diagrammatic illustration of an exemplary embodiment of a category screen having large icons on a second page;

FIG. 9 is a diagrammatic illustration of an exemplary embodiment of a station screen;

FIG. 10 is a diagrammatic illustration of an exemplary embodiment of a channel selection screen on a first page;

FIG. 11 is a diagrammatic illustration of an exemplary embodiment of a channel selection screen on a second page;

FIG. 12 is a diagrammatic illustration of an exemplary embodiment of a channel selection screen on a third page;

FIG. 13 is a diagrammatic illustration of an exemplary embodiment of a channel selection screen having larger station icons;

FIG. 14 is a diagrammatic illustration of an exemplary embodiment of graphic elements presented to a user to facilitate multi-modal input;

FIGS. 15 and 16 illustrate an exemplary embodiment of a use case for multi-modal input and content discovery; and

FIG. 17 is a block-circuit diagram of an exemplary embodiment of a computer system.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

The terms “program,” “software,” “software application,” and the like as used herein, are defined as a sequence of instructions designed for execution on a computer system. A “program,” “software,” “application,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

### Multi-Modal Input

The described systems and methods pertain to a cognitive model for secondary driving tasks that facilitates human-machine interface (HMI) design. For a given secondary driving task, HMI design rules determine when to use the following interactive modalities: speech; touch; gesture; vision; sound; and haptic feedback. Because there are multiple definitions and interpretations of these modalities, each modality is defined in the context of the HMI methodology that is described herein. The term “speech” refers to speech input from a human. The term “touch” refers to discrete interactions that indicate a selection (such as a tap or button press). “Gesture” is defined as any user input that conveys information through motion or attributes beyond simple touch (e.g., press and hold, or double tap). “Vision” includes all static and dynamic imagery viewable by a human and intended to convey task relevant information to a human; head-up displays and augmented reality are included. The term “sound” refers to all audible sounds that convey relevant task information to a human, including chimes, music, and recorded and synthetic speech. “Haptic” feedback is a vibration felt by the driver and is used to alert drivers in a natural way—a way that is simple and does not have to be learned. For example, vibration at the back surface of a driver's seat cushion can indicate that some object (e.g., a child) is very close to the rear of the vehicle. Accordingly, speech, touch and gesture are input modalities and vision, sound, and haptic are output modalities. For any given secondary task, the cognitive model, e.g., the HMI design model, can include all of these interactive modalities, or just a subset. Those familiar with the art of HMI design are aware of broader definitions of the interactive modalities referred to above.

The described systems and methods yield safe, generalized measures for completing secondary driving tasks. Such secondary tasks include dialing, messaging, navigation tasks, music management, traffic, weather, and numerous other tasks that can be enabled on a mobile device or computer. Safety is maintained by assuring that the user interface is extremely simple and quick to use. Simplicity to the driver is achieved by leveraging speech and other natural modalities, depending on the task requirements, including, but not limited to:
task selection;
natural prompting;
entering a text string;
managing results lists;
selecting from a menu;
presenting information;
scrolling;
task discovery;
content discovery;
interrupting a task;
terminating a task; and
pausing a task.

The HMI rules comply with the following constraints (not in any order):
minimize verbosity;
remove need for learning mode;
minimize speech input;
minimize glance time and frequency;
minimize task completion time;
maximize driving performance;
maximize simplicity;
minimize number of task steps;
minimize number of menu layers;
avoid voice menus;
disallow typing;
minimize incoming information (incoming messages and alerts); and/or
maximize interruptibility.

Widely accepted is the notion that speech interfaces fit nicely into the driving experience, particularly when a task requires text entry. Speech can be used to help manage secondary tasks such as navigation systems, music, phones, messaging, and other functionality—making it possible to be more productive while driving without the burden of driver distraction. However, actual usage of such speech enablement has fallen short of expectations, spurring some to blame the low usage on the unreliability of speech in the car. Regardless, keeping the primary task of driving in mind, user interfaces for secondary tasks should not require lengthy and/or frequent eye glancing (i.e., eyes off road) nor very much manual manipulation (i.e., hands off steering wheel). The ultimate goal of the present disclosure is to provide natural interfaces that are simple enough to allow the driver to enjoy technological conveniences while maintaining focus on driving. This disclosure challenges many speech interface practices and examines what it takes to achieve natural interfaces for secondary tasks. Most importantly, the present disclosure describes how to mix multiple interactive modalities to achieve optimized user experiences for most accepted secondary tasks known today. In summary, the HMI rules described here are specific to situations under which the driver's primary task is to drive safely. From a cognitive perspective, a secondary task is performed as a second priority to driving.

In today's vehicles, a speech button is commonly used to initiate a speech session that may have visual and manual dependencies for task completion. Once the speech button is pushed, a task can be selected from a voice menu. Usage data suggests that this is questionable HMI design. And, without doubt, the trend is towards freely spoken speech with no boundaries on what a user can say. But, even with such advanced speech capabilities, perhaps a speech button is still not a good idea. It can be argued that a visual-manual interface should be used for task selection and that, with appropriate icon design, the user experience would be natural. Navigation, music, messaging, infotainment, and other functionality can be easily represented with icons. Analysis has shown that it can be intuitive and natural for a driver to glance at a display and touch to select a task domain.

It has also been found that invoking voice menus in a car can lead to bad user experiences unless it is totally obvious to the user what are the menu choices. As indicated above, from a multi-modal perspective, speech, manual touch, and gesture are considered to be input modalities (from the driver to the vehicle) and visual (including head-up displays), sound, and haptic (touch) feedback are considered to be output modalities (from the vehicle to the driver). Sound can be an audio prompt that should be natural—is should be axiomatic how a driver can respond. Examples include: “Where would you like to go?”; “Please say your text message”; “What's your zip code?”; “Say a song name or an artist.” And yes/no queries can certainly be natural and necessary. “Please say a command” is an un-natural prompt, yet it is common today. The point here is that prompts should be natural to a user. In fact, every aspect of an HMI design should seem natural to a user—clear and comfortable to use.

A voice menu can be thought of as an audio version of a visual list from which to choose something. It is generally better to use a visual-manual interface for list management—it is much quicker, easier, and natural. Including a visual dependency with speech-enabled interfaces definitely makes sense when a user needs to select an item from a list, such as nearby search results. An audio interface can be cumbersome to use for list management because each item in the list has to be played out to the driver with a yes/no query after each item. Complex list items take longer to play and are more difficult for the driver to remember. In contrast, a brief glance at a list followed by a tap on the item of choice proves to be quick, reliable, and preferred by test subjects in studies on driver distraction. Consider the following recommended use case:
Driver taps the navigation icon
Vehicle asks driver “Where would you like to go?”
Driver says “An Italian restaurant that's not too expensive”
Vehicle displays top 5 search results including address, distance, and price category
Driver glances briefly
Driver selects desired restaurant by tapping.
   A similar scenario can be shown for managing music and infotainment.

Some believe that a driver should be able to glance at a list and speak the result. Others believe that the item selected should be played out using audio. But, highlighting the tapped result may be the best interface practice because a driver may have a tendency to look at the highlighted result until the audio is finished playing. Long eye glances are dangerous, with a maximum of 2 seconds being a critical limit for safety.

Now, a gesture example is considered. Controlling volume with speech does not make sense, yet many vehicles offer such a feature. It is much more natural to use gesture by turning a knob or pressing and holding a button, usually found on a steering wheel. People use gesture as an input modality all the time they drive—to steer, to accelerate, and to break (speech input will not work for these tasks). The present disclosure's definition of gesture is independent of whether touch is involved, but touch can be involved when using gestures.

Disclosed herein is a user interface that incorporates the use of gestures to provide user input. In the context of addressing the challenge of making safe user interfaces for secondary tasks, it has become accepted that gesture, as an input modality, can play a critical role toward simple interfaces for otherwise complex non-driving tasks. Gesture is a very natural human communication capability. When used in a smart way in the vehicle environment, gesture can smooth the way for controlling a vehicle head unit and also decrease driver distraction because gesture requires less precision than touch. The design goal is to allow a driver to use gesture in a natural, intuitive way to do things that would otherwise require touch and significant glancing. Gesture is generally an alternative interactive mode, not necessarily a primary interactive mode. That is, there should be multiple ways for a user to execute a particular subtask. For example, a user may use speech or touch to zoom-in on a map image, or perhaps make a simple gesture such as moving an open hand away from a screen where the map image is displayed. The following describes a gesture user interface in a vehicle, which can be used while a user is driving or the vehicle is stationary.

Analogous to speech recognition in the car, gesture detection is an interactive modality that should be activated before a meaningful gesture can detected. There are several reasons that justify the need to activate gesture, most of which have to do with usability. For speech input, the user usually presses a button to initiate a speech recognition session. After pressing the button, the system starts listening. For gesture input, the user can make a specific gesture—in a particular location relative to a touch display, using a particular hand shape (e.g., open hand), and with particular temporal properties (e.g., somewhat stationary for a minimum time duration). A small gesture icon can be displayed and a gesture-signifying chime can be played to notify the user that a gesture input is ready to be detected. Thus, a user can knowingly activate gesture without glancing at the vehicle display.

Once activated, gesture detection should time out quickly (after a few seconds) if a valid gesture is not detected. Gesture input can be three-dimensional. In addition, gesture input can include translational movement of the hand and/or movement of the hand itself. Examples of gestures include left and right hand motions (the x axis), up and down motion (the y axis) and motion toward and away from the display (the z axis). Other examples can be circular or just closing the hand after activating with an open hand. Such gestures can be used to move images on a display vertically and horizontally, zoom an image in and out, control volume, control fan speed, and to close applications. Gesture can also be used to highlight individual icons on a vehicle display. By using an open hand, the closest icon to the hand can be highlighted and, as the hand is moved, a new way of scanning icons can be realized. In another embodiment, the solution allows a user to move their hand near the display of category or station icons (or other sets of icons). As gesture is detected, the icon closest to the hand lights up and the icon category or station name is played with TTS (or a recorded prompt). To select, the driver moves their hand toward the display (like zooming in). By enabling audio feedback, drivers can keep their eyes on the road and still browse and select icons. The highlighted icon can actually be enlarged to make the selection process easier. It is noted that those gestures not involving touch are considered three-dimensional gestures. Two-dimensional gestures require touch and include actions such as turning a volume control knob or pinching a screen to zoom in.

In one exemplary embodiment, gesture input can be used to wake up the system, e.g., a head unit or a vehicle infotainment system. The number of gesture options is robust. Gesture input can be used, among other features, to move an image horizontally, scroll up/down, zoom in/out, close an application and go to a homepage, and control volume. Gesture can also be used in conjunction with speech, vision, sound, etc. to provide user input.

Haptic feedback (usually a vibration felt by a driver) is used to alert drivers in a natural way—a way that is simple and does not have to be learned. A good example of an effective use of haptic feedback is the connected vehicle technology to be used for crash alerting, though still under development. A driver feels the left side of their seat vibrate when another vehicle is dangerously approaching the driver side of the vehicle. Immediately, a driver will sense that something is wrong and from which direction. Haptic feedback may interrupt a secondary task to insure safety.

The speech button and a number of other common speech interface practices are challenged by the present disclosure. The use of a wakeup command in lieu of the speech button continues to be considered. But the acoustic environment of the vehicle suggests keeping it out of the car or at least allowing the driver to turn it off. The car relies on a hands-free microphone that picks up many spurious sounds, with possible audio artifacts that are countless. Just turning up the radio volume proves how useful a wakeup command might not be. Instead, the focus here is on what is natural and an acknowledgement is made that speech proves its value to the user experience. However, the driver is able to touch an icon or a specialized button to select a task—then invoke speech when it makes sense.

The presently disclosed HMI design rules are derived holistically. A cognitive model is provided for secondary driving tasks—a model that will indicate the best use for speech and other modalities. Simple tasks such as voice dialing can be done with an audio-only interface, combining both speech and sound. But, when tackling more complex tasks, it cannot be expected that an audio-only interface will be effective. Leveraging visual perception in a way that minimizes glance duration and frequency is the key to providing information to a driver.

Although the foregoing specific details describe exemplary embodiments of the invention, persons reasonably skilled in the art of human-machine interfaces, wireless data communication, and/or speech recognition technology will recognize that various changes may be made in the details of the method and apparatus of this invention without departing from the spirit and scope of the invention as defined in the appended claims. Therefore, it should be understood that this invention is not to be limited to the specific details shown and described herein.

Described now are exemplary embodiments of the present invention. Referring now to the figures of the drawings in detail and first, particularly to FIG. 1, there is shown a first exemplary embodiment of a sequence diagram of subtasks for a complex navigation task. The driver begins by tapping the navigation icon from the home page of the display, and then taps the destination icon shown in the second menu. The driver can pause, if needed, before tapping the destination icon. The driver is prompted to say a destination, this is usually done with audio, but the prompting could be done with text in a head-up display. In this example it is assumed that the vehicle suddenly detects danger as a nearby vehicle gets too close to the driver's side of the vehicle; the left side of the driver's seat vibrates, alerting the driver with haptic feedback. The driver makes a quick (natural) gesture that pauses the secondary task; the driver then focuses on driving only. The driver becomes comfortable and resumes the secondary task with a right-handed gesture, and then speaks the destination “Starbucks on my route.” For this request, it is assumed that there are two pages of search results (for example, 6 on page 1 and 3 on page 2). The driver glances at page 1 and decides to tap the down arrow to see the other search results. The search selection is made by tapping on the desired item and the display goes back to the main navigation screen with the new route shown.

FIG. 2 illustrates common multimodal flows for several secondary tasks, all of which are initiated with a tap, followed by a natural prompt for the driver or user to speak information/command(s). Relevant results are shown on the vehicle display such as: 1) a text message with the recipient included; 2) a search result, such as a few stock prices; 3) a list of destination search results; and 4) a list of song names. Such results are managed by glancing and tapping. There can be task icons that, when tapped, results appear without the need for a driver to speak (for example, weather could be done this way).

FIG. 3 represents the flow of generic subtasks associated with the complex navigation task illustrated in FIG. 1. Starting from the top, a task is selected using the preferred modality of touch, although a task could be selected using speech (but a button press or tap would be required to initiate the speech session). The driver sees menu choices. For such presentation, vision is a preferred modality although the menu choices could be presented aurally. For selecting the item from the list, touch is the preferred modality, although speech could be used. The driver is prompted to speak a phrase and such prompting is preferably done with audio, e.g., recorded human voice or TTS, but the prompting could be done with text in a head-up display. The driver is warned of danger using haptic feedback as the preferred modality for the type of danger depicted in FIG. 1, although sound could be used, and in many cases should be used (e.g., warning—seat belts are unbuckled). To pause a task, gesture is a preferred modality for the use case shown in FIG. 1, but touch could be used. The same holds for resuming a task. To enter a text string (while driving), the driver should or must use speech. For presenting page 1 of 2 pages of results (items to choose from) vision is the preferred modality; using sound is not recommended as it takes too long and is not always effective. To choose to go to the next page, touch is the preferred modality, although gesture can be equally effective (a swiping motion). Again, page 2 of the results is shown visually. When selecting an item from the list, touch is again the preferred modality, although speech could be used. The task is completed once the driver makes the final selection from page 2 of the results, and the display changes visually, although sound could be used to indicate task completion.

FIG. 4 illustrates an exemplary embodiment of task initiation using a speech button. In particular, FIG. 4 shows three types of usage scenarios after pressing the speech button in a vehicle. A typical speech button 405 and a vehicle touch-screen display 410 are depicted. The “Tap or say your selection” prompt encourages the user to say an icon name or tap it. For the example shown, the user can, in Scenario 1, tap the weather icon on the touch display 410 in the vehicle to get the weather application. Alternatively, the user can, in Scenario 2, say “weather” to get the weather application. In an advanced, mode, the user can, in Scenario 3, use speech to request the weather forecast for the following day.

One major problem with today's automotive speech interfaces is the fact that a typical user does not know what to say after pressing the speech button. The speech button has become a common button in vehicles and is usually located on the steering wheel. When a user presses the speech button, a prompt is usually played such as “please say a command,” implying to the user that the car is listening for something to be spoken by the user. The user speaks, but what happens after that can vary because the recognizer often has issues understanding the user's intent if a specific command phrase is not provided. Even with the advanced state that speech recognition technology has reached, speech interfaces in vehicles have a low adoption rate due to accuracy issues perceived by the users. Unexpected sounds occur frequently when a car goes into a listening mode, and these unexpected sounds are not handled well by the speech recognizer, especially when the active vocabulary is large (e.g., when there are over 1,000 items that can be recognized). In spite of low usage rates due to accuracy inadequacies, the trend has been to open up the speech recognizer (e.g., large vocabulary mode) to allow users to speak naturally to take shortcuts or make full requests. For example, speaking a radio station name from the top menu is a common speech shortcut. Yet, saying an address is not allowed. Telling the car to dial a specific name or number from the top menu is an example of a full request that is supported today. Yet, making a hotel reservation is not. Because of such inconsistencies, bad user experiences occur frequently, causing many users to dislike and not use the speech option.

To overcome the usability issues described above, a multimodal approach can be employed that is quite reliable, even for first time users. The conventional speech button can be used as a task assistant that can help manage both speech and touch input. By including touch or adding touch prompts to an existing touch system, novice users can navigate and manage tasks reliably when selecting from a limited number of options (i.e., menu items), and switch to speech input when the need to enter text arises.

For the sake of clarity, the speech button will continue to be referred as being a speech button, even when tapping is an option. For tap-or-say (TOS) scenarios, both tapping and speaking are input options. At the beginning of a secondary driving task, the user can press a speech button, and experience a “tap or say” prompt instead of a “please say” prompt. An example of an appropriate TOS prompt is: “Tap or say your selection.” A TOS prompt can be used until the user has reached a point when it is time to enter text, such as a destination, a song name, or a radio station. In one exemplary embodiment, if the vehicle is in motion, it is assumed that a user must use speech to enter text. The interface may be designed to prompt the user automatically (see FIG. 1) or the display can be used to encourage the user to push the speech button when the user is ready to say what he/she is supposed to say (like a destination). In one exemplary embodiment, pushing the speech button could invoke a third type of use case: a verbal explanation of something, perhaps not entering into a listening mode. If a user wants to select a new task, pressing the speech button can bring up a home page that is similar to that shown in FIG. 4.

The TOS approach can still allow a user to make a full request (or use shortcuts) by speaking naturally in response to “Tap or say your request.” However, such use cases are more suitable for experienced users, and the speech recognizer has to support this type of user input. In other words, the TOS approach does not have to limit what a user can do at the top menu after pressing the speech button. However, complex speech requests can lead to bad user experiences, especially under noisy driving conditions.

Another significant problem that is overcome with the inventive TOS approach is error handling. With speech interfaces, the most complex dialog flows are usually associated with error handling schemes. Speech recognition errors occur in many forms including:
Incorrect recognition (e.g., “traffic” recognized as “weather”)
No match (no guess at what was spoken)
Rejection (the best match has a low confidence score)
Timeout (spoken input not heard)
Spurious (invalid command or sound recognized as a valid command)
Spoke too soon (user spoke before listening began)
Deletion (e.g., 66132 is recognized as 6632)
Insertion (e.g., 7726 is recognized as 77126)

The prompting that is required when speech errors occur can be rather lengthy, as the user has to be told what to say and coaching is often required. When speech errors occur, the task completion time becomes excessive in duration and often unacceptable under driving conditions. Alternatively, with the inventive TOS approach, when a speech error occurs, the user is instructed to tap their selection (from a set of displayed icons or from a list of results) without being given the option to speak. No extra prompting and no extra dialog steps are required, thereby dramatically reducing the task completion time and the hassle.

FIG. 5 is a diagrammatic illustration of flows for speech recognition error handling.

FIG. 5 shows speech recognition error handling flows from a high level. At the top of FIG. 5, the diagram illustrates when a recognition result falls into one of the following error categories: no-match; rejection; timeout; or spoke-too-soon. In such a case, re-prompting occurs until a valid recognition result is obtained. If, however, too many errors occur, then the task is aborted. More specifically, in a non-TOS approach, when an error 505 occurs, the user is re-prompted with instructions at item 510. The user continues with the inefficient and un-optimized method of user input. If another error 515 occurs, the user is again prompted with the same instructions at item 530, which typically causes frustration in a driver. If the system is not sure about the response received from the user at item 520, the user is again prompted with the same instructions at item 535, causing frustration and distraction. Only when the system receives a correct/valid response at item 525, the system continues with the selected task at item 540.

With the tap-or-say (TOS) approach, as shown at the bottom of FIG. 5 in comparison, after a speech error 545 occurs, a user is instructed at item 550 simply to use touch.

Discovery

Discovery, e.g., content discovery, is a challenge in vehicles that have sophisticated infotainment systems that often include navigation, satellite radio, bluetooth connectivity, and multiple applications. Put simply, a new car owner has to figure out the vehicle's HMI properties including which functions, features, and applications are available. New car owners also have to learn the user interfaces after they discover what is available. Thus, a driver has to discover content, and then discover (if applicable) the associated user interfaces. User interface discoverability is provided using an HMI cognitive model. Content discovery is also provided using an HMI cognitive model.

Many infotainment systems are very sophisticated and include navigation, music streaming, applications, and other features provided to a user of the infotainment system, like news and/or weather. The problem with such infotainment systems is that they are too complex and very hard for a user to operate correctly without error.

For example, with respect to station discovery in a satellite radio system, there are typically twenty categories presented to a user. These twenty categories together typically include over two hundred stations. Due to the sheer number of stations and difficulty navigating all of the stations, most new users are not exposed to many radio stations that would be of interest, and thus never discover relevant content within a free trial period.

In the prior art, if no preset stations exist, a user presses a category button, scrolls through the categories, selects a category, and then scrolls through the stations. The present system discloses a content discovery system that can be applied to any infotainment option in the vehicle, e.g., an application store in the vehicle.

In one exemplary embodiment, content can be rendered through a vehicle's head unit display. To greatly facilitate content discovery, icons are used over text for several reasons:
In many cases, images can be understood faster than words.
Well-designed icons are easy to remember. Users recreate the link between a concept and its visual representation, thereby leading users to assimilate and “learn” the icon quicker than reading.
Icons can be styled in a way that follows the brand identity and can work together with other visual elements to create visual consistency within an app or website.
It is possible to label icons with short text to provide clarity to a user in ways that make speech recognition easier for a user during “tap or say” scenarios.
Icons are easy to scan and do not have to be presented in lists.

Another key to content discovery is using icons that are laid out on a screen in a way that allows a user to visually scan vertically or horizontally. Today's smart phones follow this paradigm and users are accustomed to such layout styles. In essence, there are no lists involved and it is natural for users to spot an icon and tap the icon to select it. In a vehicle, tapping or saying an icon name is acceptable.

In one exemplary embodiment, a user in the vehicle initiates a satellite radio content discovery by tapping a category button, or by using spoken input. The categories are presented as icons. The user can select a category by tapping (for example, on a touch screen) or saying the category.

Satellite radio is a good example to illustrate best practices for content discovery. SiriusXM® radio has approximately 200 radio stations and 20 categories. In one exemplary embodiment, therefore, a user can ask for the channel lineup using voice input. In response to the voice input, the user can be presented with twenty categories presented as icons with text. The user is then able to select one by tapping the category, by saying the category (for example, by speaking the text), or by using gesture. In one exemplary embodiment, gesture can be used to highlight an icon as the user's hand moves over each icon.

FIG. 6 is an illustration of an exemplary embodiment of a category screen 600. In this embodiment, the category screen shows twenty categories embodied in twenty icons (the shape, size and colors are merely exemplary and can be in any form). In this particular example, the icons correspond to content categories in a satellite radio system. The twenty categories shown in this example are: Pop, Rock, Hip-Hop/R&B, Dance & Electric, Country, Christian, Jazz/Standards, Classical, Sports, Howard Stern, Entertainment, Canadian, Comedy, Family & Health, Religion, More (which will take the user to a screen with more categories), Latin, Traffic & Weather, News/Public Radio, and Politics. Category screen 600 also shows various other icons/information. Icon 605 returns the user to a previous screen. Icon 610 presents other menu options. Icon 615 returns the user to a home screen. Element 620 is a clock function that presents the time to a user.

FIGS. 7 and 8 illustrate an exemplary embodiment of a category screen showing categories on multiple pages. In this embodiment, the category icons are larger. In addition, the page format allows for easier use of gesture to both select icons and go from one page of icons to another. In this embodiment, which assumes that there are three pages of categories but shows only two pages of categories, the content of the icons includes both an icon and a text label. FIG. 7 shows Categories on page 1 of 3. The categories shown in FIG. 7 are: Pop, Rock, Hip-Hop/R&B, Dance & Electronic, Country, Christian, Jazz/Standards, Classical, and Sports. FIG. 8 shows Categories on page 2 of 3. The categories shown in FIG. 8 are: Howard Stern, Entertainment, Politics, Comedy, Family & Health, Religion, Traffic & Weather, News/Public Radio, and More. In addition to elements 605, 610, 615, 620, which have been described above with respect to FIG. 6, FIG. 7 and FIG. 8 also include an icon 725 that alerts the user that gesture input can be provided by the user to make selections.

As shown above, icons are used to aid in content discovery. The choice of icons is made based on the following principles: speed; anchors for memory; visual style and user interface (UI) consistency; and the use of icons and text. With respect to the principle of speed, in many cases, images are faster to understand than words. Using icons can provide anchors for memory. Recreating the link between a concept and its visual representation will lead users to assimilate the association and “learn” the icon faster than reading the words. With respect to visual style and UI consistency, icons can be styled following the logo and/or brand identity and work together with other visual elements to create visual consistency within an application or website. Because there are no universally recognized icons for radio categories and some categories could be difficult to recognize, icons have been used together with their respective labels. In this manner, the icons stand out and improve the ability of a user to scan the items. In addition, the label reinforces and clarifies the meaning of each icon, and also suggests what a user can say.

FIG. 9 is an exemplary embodiment of a station screen 900. In this embodiment, the station screen 900 shows a station selected by a user. In this particular example, the user has selected the “Elvis Radio” station “Elvis 24/7 Live from Graceland.” As shown in this example, the present song that is playing is “Love me Tender.” The user has the option of starting a song that is presently shown onscreen using the “START NOW” selection or choosing to listen to whatever song or content is playing live on the station using the “GO TO LIVE” selection. Also shown on the station screen are the “CATEGORIES”, “CHANNELS”, “FAVORITES”, “SHOWS & ON DEMAND”, and “MY DOWNLOADS” selections. The CATEGORIES and CHANNELS selections, which presently use lists, are replaced with the Discovery mode of the present disclosure with iconically presented content that is selectable using touch, voice, and/or gesture input.

FIGS. 10, 11, and 12 illustrate exemplary embodiments of channel selection screens 1000, 1100, 1200, respectively. These channel selection screens have the advantage of including a channel number (channel numbers 19 to 42) of each station icon. In one embodiment, ten station icons can be included on each screen 1000, 1100, 1200.

FIG. 13 illustrates an exemplary embodiment of a channel selection screen 1300. In this embodiment, channel numbers are not included with the station icons. As such, in this embodiment, the station icons are twenty-five percent larger than the station icons included on screens 1000, 1100, 1200 and only eight station icons appear on the channel selection screen.

FIG. 14 illustrates various graphic elements presented to a user to facilitate multi-modal input in accordance with an exemplary embodiment. The idea of the multi-modal system is to integrate all three modes of command, e.g., touch, voice, and gesture, allowing the user to respond to the system prompt by using the mode that makes the most sense at that time.

The system prompt 1405 represents a system prompt given from a particular screen. The system prompt 1405 can be provided to the user by TTS, from a pre-recorded human voice, or displayed text.

The user spoken input 1410 represent words that a user can say to make a request. The words uttered by the user are recognized using speech recognition. The words inside the brackets represent the user's spoken input. For example, the words “What's the Channel line-up?” can be an acceptable spoken input.

The user gesture command 1415 is represented by a hand icon on screens when gesture detection has been activated by the user. In one embodiment, a very simple activation gesture can be used where the user approximates an open hand located near the head unit display.

The user touch command 1420 is an area on the screen indicated by a dashed line. This dashed line represents the touch area that a user can tap to activate an action using touch input. This dashed line is provided only to show the approximate touch area and is not displayed to a user.

FIGS. 15 and 16 illustrate a use case for multi-modal input and content discovery in accordance with one exemplary embodiment. The use case is embodied in six steps using screens 600, 700, 800, 900, 1000, 1100, 1200.

In this example, at step 1, the user can use speech or touch (e.g., tap the CATEGORIES button/selection) to determine the channel lineup. Although the use case shows that this sequence begins at the “Now Playing” or station screen 900, it is important to note that this sequence can begin from any screen.

At step 2, a voice request, for example, “What's the channel line-up?” brings a screen 600 with buttons for twenty categories. As stated above, the user can also obtain the channel line-up by touching the CATEGORIES button. From this screen, the user hears a system prompt that prompts the user to tap or say an option or use gesture to zoom (or browse). This screen is shown only briefly, allowing experienced users to tap or say a category without going through the step of zooming. Brief glances can be made by experienced users. In one embodiment, this screen is shown for about five seconds.

At step 3, the user approaches their hand towards the screen. This gesture both activates the gesture commands (as indicated by the hand icon 725 on screens 700, 800, 1000, 1100, 1200) and also zooms-in to display less options.

At step 4, the screen 700 now displays only nine categories at a time, indicates the total number of pages, e.g., 1 out of 3, and the system prompts the user to tap or say an option. In one embodiment, when no category is selected, the display stays on for a brief moment, e.g., about five seconds, and shifts automatically to the next category page, e.g., screen 800, so that all categories can be seen without further input by the user. In another embodiment, if no categories are selected by the user after displaying all categories once, the display returns to the original screen, e.g., the screen from step 1, which in this case is screen 900. In this case, the user actually chooses a category using tap or a voice command to choose the “Rock” category.

At step 5, the user is presented with the first ten stations within the particular category, in this case “Rock”, on screen 1000. This screen 1000 also indicates the total number of pages within the category, which in this case is 1 out of 3. In one embodiment, when no station is selected, the display stays on for a brief moment, e.g., about 5 seconds, and shifts automatically to the next ‘rock stations’ page, e.g., screen 1100 and then screen 1200, so that all rock stations can be seen without further input by the user. In another embodiment, if no stations are selected by the user, after showing all of the stations once, the display returns to the original screen, e.g., the screen from step 1. In this case, the user actually chooses a station using tap or a voice command to choose the ‘Elvis 24/7 Live from Graceland’ station.

At step 6, the user is presented with the “Now Playing” screen, e.g., screen 900. At any time the user can use a voice command or press the CATEGORIES button/selection to resume browsing.

FIG. 17 illustrates a block diagram of an exemplary computer system according to one embodiment. The exemplary computer system 1700 in FIG. 17 can be used to implement multi-modal input module 1785 and discovery module 1790 using a head unit or infotainment system. Those skilled in the art would recognize that other computer systems used to implement this device may have more or less components and may be used in the disclosed embodiments.

The computer system 1700 includes a bus(es) 1750 that is coupled with a processing system 1720, a power supply 1725, volatile memory 1730 (e.g., double data rate random access memory (DDR-RAM), single data rate (SDR) RAM), nonvolatile memory 1740 (e.g., hard drive, flash memory, Phase-Change Memory (PCM)). The processing system 1720 may be further coupled to a processing system cache 1710. The processing system 1720 may retrieve instruction(s) from the volatile memory 1730 and/or the nonvolatile memory 1740, and execute the instruction to perform operations described above. The bus(es) 1750 couples the above components together and further couples a display controller 1770, one or more input/output devices 1780 (e.g., a network interface card, a cursor control (e.g., a mouse, trackball, touchscreen (for touch/tap input), touchpad, etc.), a keyboard, etc.). The one or more input/output devices also include voice recognition and gesture recognition elements so that the head unit is capable of receiving speech and gesture input as well as touch/tap. In one embodiment, the display controller 1770 is further coupled to a non-illustrated display device.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the figures can be implemented using code and data stored and executed on one or more electronic devices (e.g., a head unit, a vehicle infotainment system). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable communication media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more buses and bridges (also termed as bus controllers). Thus, the storage device of a given electronic device typically stores code and/or data for execution on the set of one or more processors of that electronic device. Of course, one or more parts of an embodiment of the invention may be implemented using different combinations of software, firmware, and/or hardware.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The phrase “at least one of A and B” is used herein and/or in the following claims, where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

1. A method for providing a multimodal user interface, which comprises:
providing in a vehicle:
a multi-modal input module defining human-machine interface design rules; and
a human-machine interface (HMI) that utilizes a plurality of modalities; and
providing a secondary driving task cognitive model indicating when to use one or more particular modalities of the HMI for performing each secondary driving task dependent upon the HMI design rules.

2. The method according to claim 1, wherein the plurality of modalities include at least two of speech, touch, gesture, vision, sound, and haptic feedback.

3. The method according to claim 2, wherein:
speech, touch, and gesture are input modalities; and
vision, sound, and haptic feedback are output modalities.

4. The method according to claim 1, which further comprises providing the cognitive model with all or a subset of the plurality of modalities for any given secondary driving task.

5. The method according to claim 2, which further comprises activating gesture detection prior to detection of gesture input.

6. The method according to claim 5, wherein gesture input includes at least one of a specific gesture:
in a particular location relative to a touch display;
using a particular hand shape; and
with particular temporal properties.

7. The method according to claim 6, which further comprises providing a notification that gesture input is ready to be detected.

8. The method according to claim 6, which further comprises allowing gesture detection to time out when a valid gesture is not detected.

9. The method according to claim 6, which further comprises providing three-dimensional gesture input.

10. The method according to claim 9, wherein the three-dimensional gesture input is at least one of translational motion of a hand and movement of the hand itself.

11. The method according to claim 6, further comprising using gesture input to:
move images on a display of the vehicle;
zoom the image in and out;
control volume;
control fan speed; and
close applications.

12. The method according to claim 6, which further comprises using gesture input to highlight individual icons on a display of the vehicle.

13. The method according to claim 6, which further comprises waking up a vehicle system using gesture input.

14. The method according to claim 1, which further comprises using haptic feedback to interrupt the secondary driving task.

15. The method according to claim 1, which further comprises:
first, initiating the secondary driving task with a tap; and
second, prompting a user to speak information or a command.

16. The method according to claim 1, which further comprises prompting a user with audio or text to enter user input.

17. The method according to claim 16, wherein the audio is human voice or text-to-speech (TTS).

18. The method according to claim 16, wherein:
a user is prompted using text; and
a head-up display displays the text to the user.

19. The method according to claim 3, which further comprises using a conventional speech button to manage both speech and touch input modalities.

20. A method for providing a multimodal user interface, which comprises:
providing in a vehicle:
a multi-modal input module defining human-machine interface design rules; and
a human-machine interface (HMI) that utilizes a plurality of modalities; and
providing a secondary driving task cognitive model indicating when to use one or more particular modalities of the HMI for performing each secondary driving task dependent upon HMI design rules;
initiating a secondary task; and
interrupting the secondary task the secondary task to ensure safety.
